(19) United States
(12) Patent Application Publication
(10) Pub. No.: US 2011/0047557 A1
(43) Pub. Date: Feb. 24, 2011

(54) METHOD AND APPARATUS FOR EXPEDITED SERVICE INTEGRATION USING ACTION TEMPLATES

(75) Inventor: Olli Oskari KOSKIMIES, Helsinki (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/544,044

(22) Filed: Aug. 19, 2009

(51) Int. Cl. G06F 9/46

(52) U.S. Cl. 719/315

(57) ABSTRACT

An approach is provided for expedited service integration using action plugin templates. Context information and a target object are determined. A plugin based on a template configured for a service provider is received. A plugin action is determined using the target object and context information. Execution of the plugin on the target object is initiated to perform the plugin action.

### BACKGROUND

Wireless (e.g., cellular) service providers and device manufacturers are continually challenged to deliver value and convenience to consumers by, for example, providing compelling network services. Important differentiators in this industry are application and network services as well as making it easier and more convenient to develop or access these services. Applications run on mobile devices, but traditionally, the costs for developing these applications is great.

### SOME EXAMPLE EMBODIMENTS

According to one embodiment, a method comprises determining context information and a target object. The method also comprises receiving a plugin based on a template configured for a service provider. The method further comprises determining a plugin action using the target object and the context information and initiating execution of the plugin on the target object to perform the plugin action.

According to another embodiment, an apparatus comprising at least one processor, and at least one memory including computer program code, the at least one memory and the computer program code configured to, with the at least one processor, cause the apparatus to determine context information and a target object. The apparatus is also caused to receive a plugin based on a template configured for a service provider. The apparatus is further caused to determine a plugin action using the target object and the context information and initiate execution of the plugin on the target object to perform the plugin action.

According to another embodiment, a computer-readable storage medium carrying one or more sequences of one or more instructions which, when executed by one or more processors, cause an apparatus to determine context information and a target object. The apparatus is also caused to receive a plugin based on a template configured for a service provider. The apparatus is further caused to determine a plugin action using the target object and the context information and initiate execution of the plugin on the target object to perform the plugin action.

According to another embodiment, an apparatus comprises means for determining context information and a target object. The apparatus also comprises means for receiving a plugin based on a template configured for a service provider. The apparatus further comprises means for determining a plugin action using the target object and the context information and means for initiating execution of the plugin on the target object to perform the plugin action.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of expedited service integration using action plugin templates, according to one embodiment;

FIG. 2 is a diagram of the components of a user equipment, according to one embodiment;

FIG. 3 is a flowchart of a process for configuring an action plugin template for service integration, according to one embodiment;

FIG. 4 is a flowchart of a process for executing an action plugin for service integration, according to one embodiment;

FIG. 5 is a diagram of user interfaces utilized in the processes of FIG. 4, according to one embodiment;

FIG. 6 is a diagram of hardware that can be used to implement an embodiment of the invention;

FIG. 7 is a diagram of a chip set that can be used to implement an embodiment of the invention; and

FIG. 8 is a diagram of a mobile station (e.g., handset) that can be used to implement an embodiment of the invention.

### DESCRIPTION OF SOME EMBODIMENTS

A method and apparatus for providing expedited service integration using action plugin templates are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

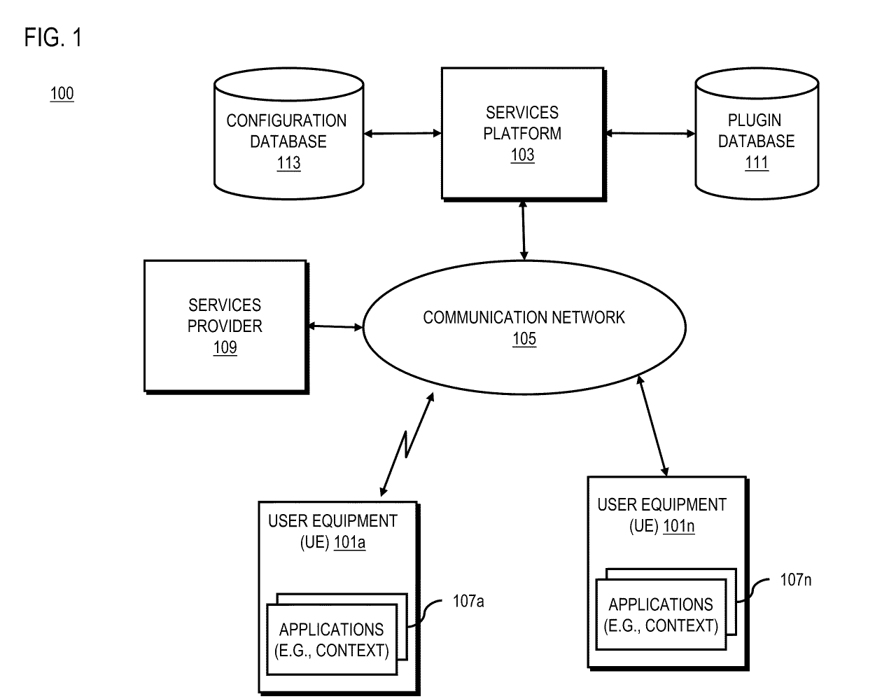

FIG. 1 is a diagram of a system 100 capable of providing expedited service interaction using action plugin templates, according to one embodiment. Integration of services with mobile devices takes substantial effort and provides a mild benefit for service providers over customary services provided by the service providers. Thus, a low effort alternative to creating service applications can be useful. Additionally, there is a lack in convenient ways to access a service when a multitude of services are available.

To address this problem, a system 100 of FIG. 1 introduces the capability to expedite service integration using action plugin templates. The system 100 can be used to integrate web-based services to mobile phones with limited effort by using action plugins based on templates that can be configured by a service provider or user. The action plugin can be executed on a target object (e.g., a contact or an image). In one embodiment, an action plugin can take the target object and a current context (e.g., user location) as parameters and use the parameters to execute the plugin action. For example, the plugin action can include opening a web page in a web browser. In another example, the web page can be directed at navigation (e.g., finding a route to a destination). In this example, the user's current address can be a current context parameter, and a contact in the user's phone book can be a target object. The destination parameter to the route finding service can be the street address of the contact. Thus, the user can be directed to a map and instructions for getting to the street address of the contact from the current location of the user without manually opening a browser, without navigating to a mapping service, and without having to enter address data. In another embodiment, when a user views contact information of a person, the user can access different services related to the person via different action plugins (e.g., for travelling to the person, for sending flowers or other gifts, for finding a restaurant close to the person, etc.). In yet another embodiment, when a user views an image, the user can access services for uploading the image to a web album, for ordering a mug or t-shirt with the image, or for offering the image to a newspaper. In one example, when the user views a calendar entry, the user can access services for travelling to the location of the meeting, for determining the weather at the time and location of the meeting, or for ordering food from a restaurant nearby the meeting.

Under the scenario of FIG. 1, the system 100 involves user equipments (UEs) 101a-101n having connectivity to a services platform 103 via a communication network 105. The UE 101 can utilize a context application 107a-107n to utilize the services of a service provider 109. The application 107 can utilize a plugin (i.e., an action plugin) that is stored in a plugin database 111 of the services platform 103. The plugin can be configured by a service provider 109 or a service user (e.g., by using a UE 101 or another device). The configuration settings can be stored in a configuration database 113. Additionally, the services platform 103 can comprise a store.

In one embodiment, the services platform 103 includes a plugin database 111. The plugin database 111 can include action plugins as well as action plugin templates that a service provider 109 can configure to create action plugins. In one example, no changes are needed for the service provider 109. In another embodiment, the service provider 109 can include a link (e.g. a Uniform Resource Locator (URL)) for a website that provides a service to users. By way of example, action plugin templates can include actions for opening a link in a web browser, sending a Simple Object Access Protocol (SOAP) or REpresentational State Transfer (REST) request, sending a short message service (SMS), sending a multimedia messaging service (MMS), sending an e-mail, running a piece of JavaScript code, executing an application, or the like. The templates can be set up with the requisite instructions to execute on a UE 101. Some templates can be specific to a certain type, brand, or model of UE 101.

In one embodiment, the service provider 109, a user, or a third party can generate an action plugin using a web-based development service. In this embodiment, the service provider 109 can connect to the services platform 103 to configure plugins. Configured plugins can be stored in a plugin database 111. Under one scenario, the service provider 109 can provide services for traveling (e.g., a navigation service, a taxi service, a public transportation guide, or the like), for gifts and greetings (e.g., a gift helper service to help choose a gift for a person, a gift sales service, a flower delivery service, or the like), a sharing or publishing service (e.g., a magazine news photo submission service, a home videos submission service, a photo sharing service, or the like), or a shopping or food service. The service provider 109 can configure a plugin by selecting and configuring an action plugin template. The plugins can be configured to use target objects and a current context as input parameters.

A UE 101 can utilize the plugins by running a context application 107. The context application 107 can display options to a user of the UE 101 to choose action plugins associated with a target object. In one embodiment, a UE 101 can download plugins and configurations from a services platform 103. In another embodiment, a UE 101 can download a plugin library from the services platform 103. In this embodiment, the plugin library can include configurable plugins and/or standalone plugins. In one embodiment, the UE 101 can browse a service provider 109 web page and can download a plugin or a plugin configuration from a service integration link on the web page. The plugin configuration combined with the configurable plugin can be used to create executable plugins or can be executed together. In one embodiment, a target object can be a contact in a phone book (e.g., where the action can be to travel to the contact, or send something to the contact), an image (e.g., where the plugin action can be for posting the image or the like), or any other object viewed using a UE 101. A plugin can take the target object and a current context (e.g., a user location or a time) as parameters for the action implemented by the plugin, such as opening a web page in a browser. In one embodiment, the user's current address and the home address of the selected contact item are used as parameters for opening a web page from a public transportation route finder service that shows the available public transportation routes between the addresses. In one embodiment, a public transportation route finder service plugin will only be displayed as a plugin option if the target object has a home address and the public transportation is available.

As shown in FIG. 1, the system 100 comprises a user equipment UE 101 having connectivity to a services platform 103 and a service provider 109 via a communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 101 is any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the UE 101 can support any type of interface to the user (such as “wearable” circuitry, etc.).

By way of example, the UE 101, the services platform 103, and service provider 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

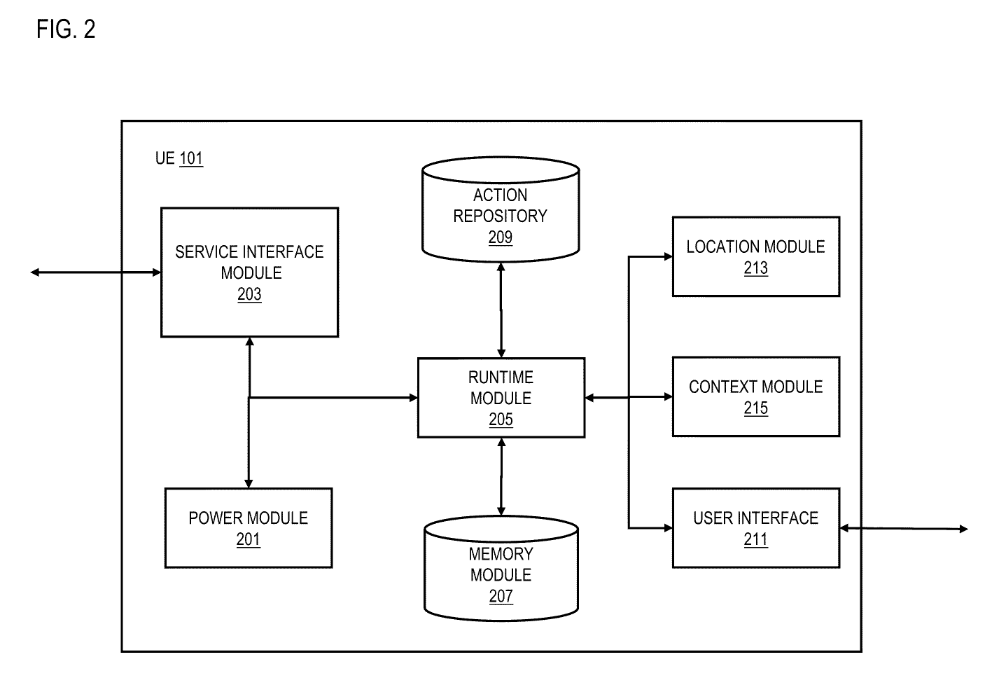

FIG. 2 is a diagram of the components of a UE 101, according to one embodiment. By way of example, the UE 101 includes one or more components for running action plugins for service integration. It is contemplated that the functions of these components may be combined in one or more components or performed by other components of equivalent functionality. In this embodiment, the UE 101 includes a power module 201, a service interface module 203, a runtime module 205, a memory module 207, an action repository 209, a user interface 211, a location module 213, and a context module 215.

The power module 201 provides power to a UE 101. The power module 201 can include any type of power source (e.g., battery, plug-in, etc.). Additionally, the power module 201 can provide power to the components of the UE 101 including processors, memory, and transmitters.

In one embodiment, a UE 101 includes a service interface module 203. The service interface module 203 can be used by the runtime module 205 to communicate with a services platform 103 or a service provider 109. In some embodiments, the service interface module 203 is used to download plugin libraries, plugin configurations and/or standalone plugins to store in the action repository 209. Additionally, the service interface module 203 can be used by the runtime module 205 to browse content of the service provider 109. Further, the runtime module 205 can execute plugins to communicate with a service provider 109 via the service interface module 203.

In one embodiment, a UE 101 includes an action repository 209. The action repository 209 can include a plugin library, plugin configurations, and/or standalone plugins. The plugin library can include configurable plugins based on templates that can be executed in combination with a plugin configuration. The plugin library and configurations can be downloaded from the service provider 109 or the services platform 103. Additionally or alternatively, the UE 101 maker may install plugin libraries, plugin configurations and/or standalone plugins in the UE 101 at manufacture time. One plugin in the plugin library can be used to open a web page, another plugin can be used to send information via a MMS, and yet another plugin can be used to send information via SOAP or REST. In one embodiment the SOAP or REST services plugin can be a submission and reply handling plugin. When the runtime module executes a configurable plugin, the plugin can use the configuration provided by a service provider, as well as data content about the current target object (e.g., a contact item) and/or current context as parameters. In one embodiment, the plugin is signed by the maker of the UE 101. In this embodiment, the plugin can fully utilize the UE 101. In another embodiment, security can be controlled by the maker of the UE 101 by only allowing the use of action plugin templates created by or authorized by the maker of the UE 101.

In one embodiment, a UE 101 includes a user interface 211. The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, etc. A user can input a request to upload or receive object information via the user interface 211. In one embodiment, the user interface 211 can include a list view, where the user can be viewing many items, but is focused on a specific target object (e.g., by activating a context menu of the item). In this view, commonly used actions can be displayed in an action toolbar. The action toolbar can be expanded to display additional actions. In another embodiment, the user interface 211 can include a detail view, where a target object is associated with the entire view. In a contacts detail view, the most commonly used actions can be emphasized. For example, the detail view can have both a service menu action offering access to applicable action plugins by category, and/or direct access links for the most popular action plugins. An example of a detail view is when a user is viewing an image taking up the screen or when a user is viewing a single contact. In another embodiment, the user interface 211 can have a home-screen. An action that need not require a target object (e.g., ordering a taxi to the user's location) can be accessed from a home-screen that can display multiple action plugins.

In one embodiment, a UE 101 includes a location module 213. This location module 213 can determine a user's location. The user's location can be determined by a triangulation system such as Global Positioning System (GPS), Assisted GPS (A-GPS), Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 213 may also utilize multiple technologies to detect the location of the UE 101. GPS coordinates can give finer detail as to the location of the UE 101 when media is captured. The runtime module 205 can also extrapolate addresses from the information gathered from the location module 213.

In one embodiment, a UE 101 has a context module 215. The context module 215 can obtain contextual information about a user of the UE 101. In one example, the context module 215 can retrieve location data of the user. In another example, the context module 215 can retrieve temporal data (e.g., a contact's birthday or a calendar) about a target object. In a further example, the context module can obtain other context data or content data about the target object.

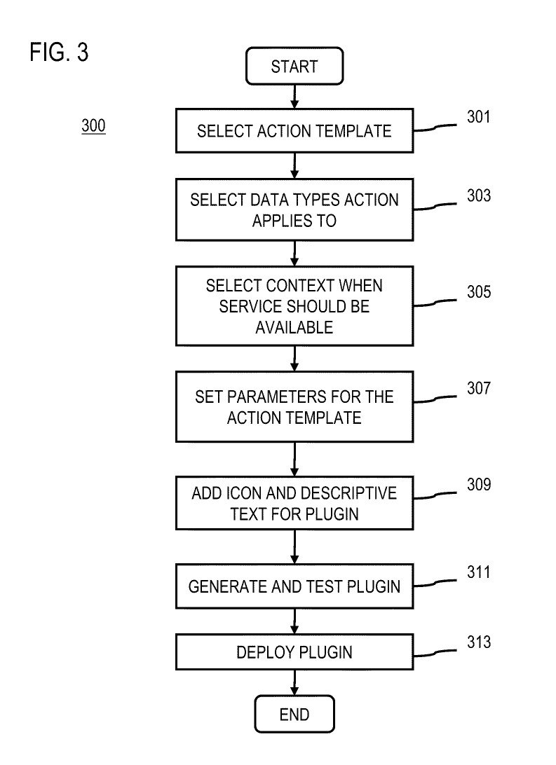

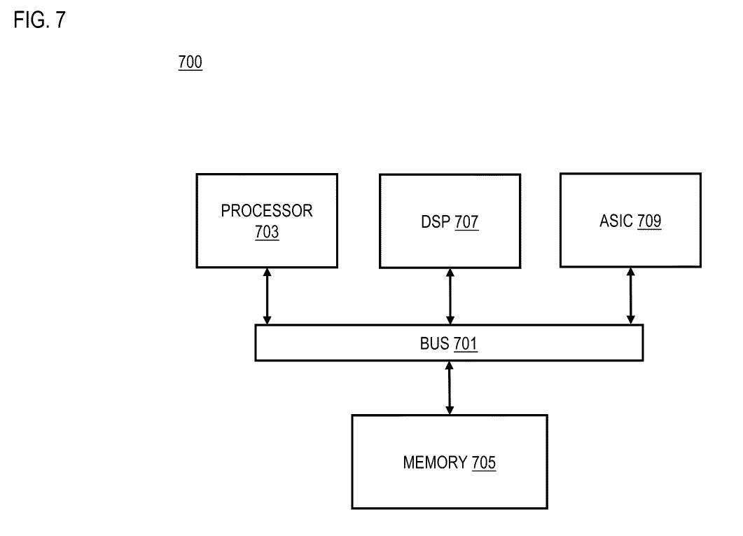

FIG. 3 is a flowchart of a process for configuring an action plugin template for service integration, according to one embodiment. In one embodiment, the services platform 103 or service provider 109 performs the process 300 and is implemented in, for instance, a chip set including a processor and a memory as shown FIG. 7. The exemplary embodiments discuss the configuration based on a service provider 109 input, however any configuration user, such as a user, a third party, the service provider 109, an administrator of the services platform 103, a UE 101 maker, or the like can provide input for configuration. Additionally, exemplary embodiments discuss the configuration on the services platform 103, however, the configuration can occur on various platforms with the configuration software. The configuration process can be manual by a service provider 109 editing a configuration file using an editor, or via a configuration service via the services platform 103. In one embodiment, if using the manual process, the service provider 109 can host the configuration file and can link to it via a service web page. In this embodiment, plugin libraries can be retrieved using UE 101 software updates and downloads, while configuration files can be downloaded. The configuration files can have identifiers such as names and version numbers. In another embodiment, the service provider 109 utilizes a configuration service. In step 301, a services platform 103 can receive a request to select an action plugin template to configure. The services platform 103 then selects the template for configuration. Exemplary action plugin templates can include an open a link in a browser action plugin template, a send via REST/SOAP action plugin template, a send via SMS/MMS/e-mail action plugin template, an execute JavaScript action plugin template, or the like.

In one embodiment, the action plugin template includes an “open a link in a browser” action. For example, the link can be specified as a URL. When a configured plugin created from the action plugin template is executed, the URL specified in the configuration is opened in a browser. A Hypertext Transfer Protocol (HTTP) can have multiple methods of indicating a desired action (e.g., HEAD, GET, POST, PUT, DELETE, TRACE, OPTIONS, and CONNECT). Parameter values (e.g., context information and target object information) can be auto-filled by a UE 101 if the values are known or can be determined based on context data or content data about the target object. Additionally or alternatively, parameter values can be supplied by a user.

In one embodiment, the action plugin template includes a “send REST/SOAP request” action to handle a submission (e.g., textual content) and corresponding reply. Parameters for such a plugin based on the template can include an HTTP method, a URL to open, a request for content, and a return value interpretation. In this embodiment, parameter values can be included in a URL. Textual content can be submitted or entered directly in a text box with input parameter references. Once the request is sent and return response is received, the response content can be processed and interpreted to generate an event. In one embodiment, the response content can be represented by a list of pairs (e.g., a matching expression, interpretation, etc.). The plugin can then match the response content with the list of pairs. For example, a matching expression may be a regular expression (e.g., “<error_{—}24>”), which can be matched to a message “Failed to upload image”. Thus, upon receiving a response containing text “error_{—}24”, the action plugin can then generate an event to show the error message to the user.

In one embodiment, the action plugin template includes a “send SMS/MMS/E-mail request” action for performing messaging functions. In this embodiment, the requests can be for a messaging service or a text messaging service. Parameters for a plugin based on the action plugin template can include a receiver, a subject, text, an attachment, and/or a receipt. In one embodiment, an attachment is provided in a MMS message or an e-mail.

At step 303, the services platform 103 can provide data types for selection by a service provider 109. The services platform 103 can then apply the action to the selected data type or types. Thus, the service provider 109 can choose the type of data objects the plugins of the service provider 109 applies to. Examples of such data objects include contacts, landmarks, images, calendar events, and videos. In one embodiment, the action is available on a UE 101 that downloads the configured plugin for data objects of the selected types. More than one type can be selected. Configuration can be segregated based on each type to offer more complete details.

At step 305, the services platform 103 can provide one or more contexts of when the service should be available for selection by a user of a configured plugin. In one embodiment, the service provider 109 is displayed available object data and context information parameters (e.g., contact.name.first, contact.name.last, contact.home-address, contact.location.gps, contact.location.address, context.time, context.connection-type, context.user.home-address, context.location.gps, context.location.address, contact.address.home, etc.). An example of a contact.name.first input is the first name of the contact (e.g., “John”) and can be displayed to the service provider 109 for context when the service provider 109 is completing configuration. An example of context.location.address is the address of the current location of a UE 101. Additionally, an example of context.address.home is the address of the home location of a target object. In one embodiment, the current address can be determined from a GPS location. For a media object (e.g., a video or an image), available context information could be the encoding of the image, (e.g., image.data.binary or image.data.base64). Once the input context is selected, the service provider can be provided an option to define, for each chosen data object type, the context of when the action plugin should be available. In an exemplary embodiment, a Boolean expression can be used to offer public transport services only when current and destination addresses are known and the current or destination city has public transportation services. When executed, the plugin will only be available (e.g. shown to the user via UI 211 as selectable action) if the current address and destination address are available and it can be determined that there is public transportation available.

At step 307, the services platform 103 can provide parameters for the action plugin template for selection by the service provider 109. The service provider 109 can provide mappings of an available data object and context attributes to action plugin template parameters. For example, in an “open link in browser” action plugin template, the service provider 109 can provide the URL with parameters. One example of a URL with parameters can be: [root address]/currentlocation=$(context.location.address)&destinationlocation=$(contact.home-address). In this example, the requisite parameters can be current and destination location for a route mapping service expressed e.g. as street addresses.

At step 309, the services platform 103 provides an option to add descriptive text for the action plugin template as well as resulting plugin. In this embodiment, the service provider can set a description of the plugin. The description can include an icon or descriptive text that can help a user determine what action the plugin performs. The description can also include styling information, such as background color, font, etc. Additionally, the description can use input parameters or be provided in multiple languages. In one embodiment, the input parameters used in the description can include context information and content data about the target object (e.g., “Travel to the home address of $(contact.name.first) from (context.location.address) by public transportation”).

At step 311, the services platform 103 can generate and test a configured plugin. In one embodiment, the output can be an installation package that can be downloaded and used by UEs 101. The installation package can be signed by a UE 101 manufacturer to allow more actions on the UE 101. For example, the manufacturer can discriminate between UEs 101 so that a plugin on devices with limited functionality (e.g., a device version not having particular context or content data directly available) can include a means for harvesting the context or content data. In one embodiment, a UE 101 does not have an address contact.home-address variable, but has a contact.address variable, the harvesting means can link the contact.address to the contact.home-address variable. In another embodiment, the services platform 103 can test the plugin. For action plugin templates that are not based on SMS or MMS, the plugin generation service can allow the service provider 109 to test the new configuration by executing it on the server using test values for the contextual data. For example, in an “open link in browser” plugin, the service can directly open a web page just like a UE 101 would. For REST/SOAP request, the service can complete the invocation and show the result (e.g., eXtensible Markup Language (XML)) as text. For an e-mail message, the service can send the email using an e-mail account associated with the service provider 109.

At step 313, the action plugin can be deployed. Once generation of the plugin is completed, it can be made available to users of a service (e.g., a service provided by the service provider 109). Different versions might be needed for different platform UEs 101. In one embodiment, the services platform 103 provides JavaScript code that the service provider 109 can add to a web page of the service provider 109. The JavaScript code can be accessed by a UE 101 to obtain the plugin. When accessed the JavaScript code can check whether it is running on a compatible UE 101 and whether the plugin has been installed. If the plugin has not been installed, the plugin can be installed at either the web page of the service provider 109 or another site. In one embodiment, the deployment can be based on a generic plugin library and a separate configuration file). The plugin library with generic plugins can be installed to the UE 101 at manufacture time or at later download time. Plugins based on the generic plugins from the plugin library can be configured using a configuration file. The configuration file can be installed to the UE 101 at the same time or separately (e.g. at manufacture time, or by later download from the service provider 109 or the services platform 103).

In one embodiment, the services platform 103 can charge fees to provide service providers 109 premium options. Premium options can include advancing the service of the service provider 109 to a more favorable position in relation to plugins of other service providers 109. A premium option can also include placement of a restricted service category (e.g., shopping services can be restricted without a subscription fee). Additionally, a code (e.g., an activation code or featured service provider code) can be sold in timeshares to feature the service provider 109 (e.g., by placing the featured service provider in a more favorable screen position or list position) on UEs 101 running action plugins. The codes can be included in the plugin configuration and may be updated. Thus if service provider 109 A buys one timeshare, B buys 2 timeshares, and C buys 2 timeshares, service provider 109 A can be featured 20% of the time, while service providers 109 B and C are each featured 40% of the time that a certain target object type is targeted. In another embodiment, the user of a UE 101 can set the featured services by rating the service (e.g., by a star rating) or by using a favorites menu. Thus, a user or the service provider 109 can filter the availability or display of services.

With the above approach, a service provider 109 can integrate the provider's services with a user's UE 101 with little effort and cost. In this manner, the service provider 109 can make available, through the core user interface of a UE 101, the services of the service provider 109. When a UE 101 utilizes the approach, the user can increase the efficiency of the UE 101 by accessing the service provider quickly and easily using the action plugin. Because some of the information can be filled using context data or content data about the target object, the UE 101 can save key presses from the user and valuable battery life.

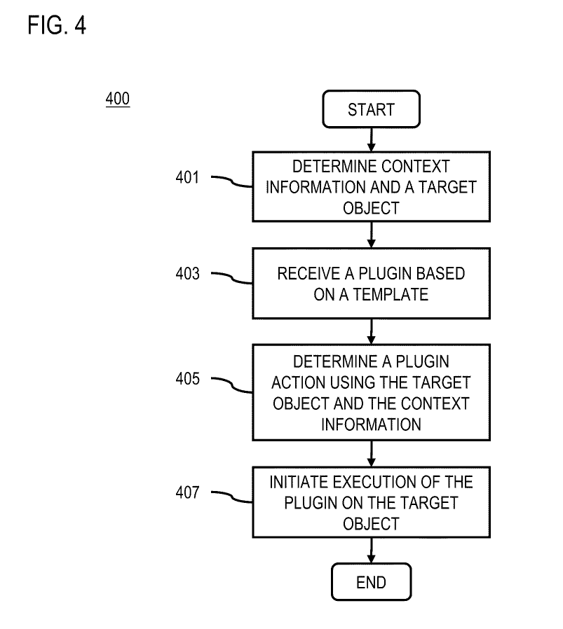

FIG. 4 is a flowchart of a process for executing an action plugin for service integration, according to one embodiment. In one embodiment, the runtime module 205 performs the process 400 and is implemented in, for instance, a chip set including a processor and a memory as shown FIG. 7. A UE 101 can browse service provider 109 websites to retrieve action plugins. In one embodiment, the action plugins come in modules. A set of configurable plugins can be downloaded in a plugin library and then configurations can be downloaded as a configuration file. In another embodiment, action plugins can be generated by a configuration service of a services platform 103. Once the action plugins are downloaded to a UE 101, the UE 101 can utilize the plugins by enabling a context application 107. In step 401, the runtime module 205 determines context information and a target object. In this embodiment, the target object can be any object of a UE 101 (e.g., a contact in a list view or a detail view). In some embodiments, there is content data about the target object associated with the object (e.g., in metadata or in a parameter list). In one example, the target object is a contact in a contact list and has a contact first name, a contact last name, a contact home address, a contact GPS location, and a contact business location address as content data items. In this example, the various content data items of the contact can be used as an input to the plugin. Action plugins can be configured to be associated with certain target object types (e.g., object types that contain data associated with the action). Thus, when a compatible target object is on a UE 101 display, the context application 107 can display action plugins associated with the target object. For example, a birthday card service action can be offered to a user when the viewer is viewing a contact who's birthday is within a certain time period (e.g., within two days). In another embodiment, the context application 107 can display image printing services plugins to a user while the user is viewing an image.

At step 403, the runtime module 205 can receive a plugin based on a template configured for a service provider 109. A user of the UE 101 can select the plugin to utilize by selecting one associated with an icon or textual description on a UE 101 interface. The plugin can be stored in an action repository 209 until received by the runtime module 205. The runtime module 205 can store the plugin in a memory module 207 while utilizing the plugin. In one embodiment, the plugin is in one package. In another embodiment, the plugin has a plugin library component that has generic plugins (e.g., “open in browser,” “send SMS,” etc.) and a configuration component (e.g., a text-based configuration file, or other configuration file, containing for example the particular URL to open in browser, with particular context and/or content data parameters).

At step 405, a plugin action is determined using the target object and the context information. At step 407, execution of the plugin is initiated on the target object. In one embodiment, content data about the target object is used to execute the plugin. Pertinent contextual data is also used. Context data can include data about the user environment (e.g., location of user), timing information (e.g., a user appointment, current time and date), or similar information. Content data about the target object can include personal information (e.g., name, home location, birth date, etc.), relationship information (e.g., contact is a coworker, relative, etc.), or any other information that can be associated with a target object that can be used in providing a service.

In one embodiment, the contextual information available at a particular UE 101 may not be compatible with an action plugin, but may be processed to become compatible. For example, an action plugin may expect a user's age, but the only raw information available is the user's birthday. The action plugin can process the available information to determine the birthday. Processing functions can be used in a hierarchy (e.g., first option is user.age, if no user.age is found, a second option of a function with inputs of context.date and user.birthday can be used to determine age). In another embodiment, if contextual information or content data about the target object cannot be retrieved or processed, the user can be requested to input the data. In some embodiments, these values are static, in other embodiments, the values can be dynamic. With static values, these values can be requested once and utilized thereafter. However, it is noted that, in certain embodiments, the user can be provided with the capability to change the static values. Dynamic values involve requesting the user for the values each time the plugin is activated. Examples of static values include a user name, a password, etc.; a dynamic value can be, for instance, a text description for a submitted image.

In one embodiment, the target object is an image. The user can be displayed action plugins to purchase a mug or t-shirt with the image displayed, submit the image for a news service, or share the image on a social networking service. By way of example, if a user wishes to upload a photograph using an action plugin, the plugin can ask for input as to the access rights of people to the photograph (e.g., public, only friends can see, only co-workers can see, etc.) or ask for personalized comments for the photograph.

In another embodiment, multiple actions can be offered by a single service provider 109 for a single target and/or context (e.g., viewing an appointment on a calendar application). For a travel and hospitality service, one action could be to offer a means of travel to the appointment (e.g., a taxi service). Another action could be to offer lodging or eating services. In another embodiment, the context could be for traveling to a contact's location. A travel service could give options to travel to the contact's location from the current location of the UE 101 or from the home address of the user. After the initial action is completed using the action plugin, the service provider 109 may provide additional services (e.g., requesting a confirmation for a taxi).

Using the above approach, a user can conveniently access a service using a context browser of the user's UE 101. Thus, services are made available through the UE 101 user interface and can be offered based on the context of the user. In this manner, context-based filtering is used to show the most useful actions to a user based on the current target object. Because information can be filled out via context data and content data about the target object, the user can avoid tedious manual data entry, which is particularly cumbersome on mobile devices.

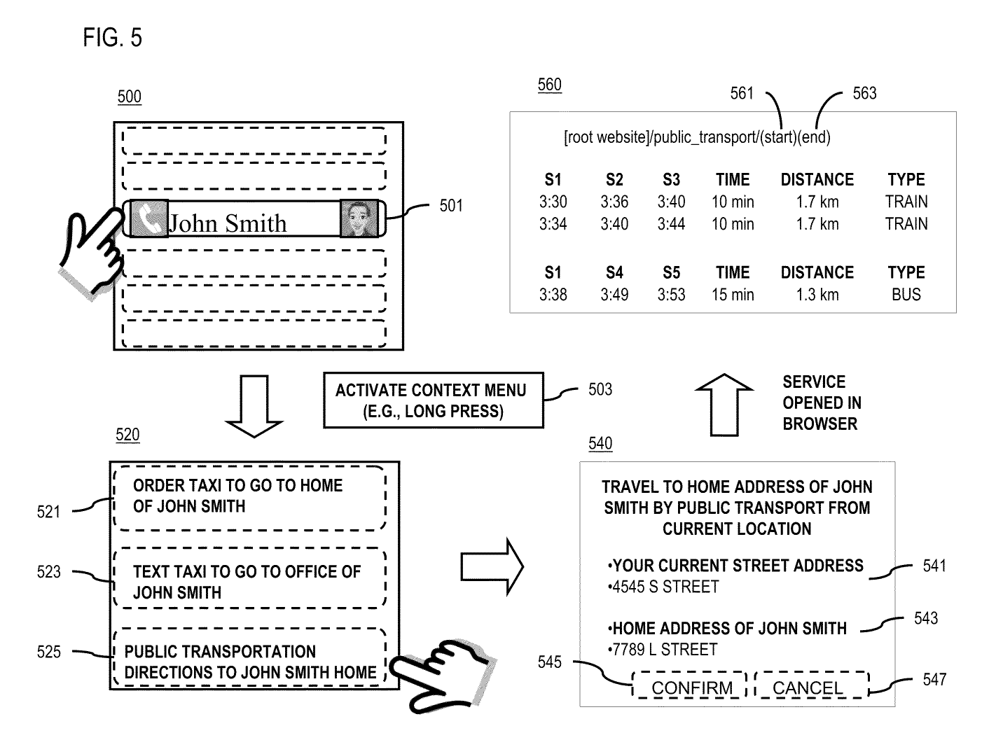

FIG. 5 is a diagram of user interfaces utilized in the processes of FIG. 4, according to one embodiment. User interface 500 displays a contact list view of a UE 101. The contact of John Smith is selected as a target object 501. A context menu 520 can be displayed by the UE 101 via an input 503 by a user. By way of example, the context menu can be activated by pressing a UE 101 button or touching on a target object item if a touch screen is used. For example, the key press or touch event to activate the context menu may be of configurable duration (e.g., long press). In one embodiment, the activated context menu 520 is overlaid on top of the user interface 500. In this embodiment, action plugins 521, 523, 525 can be displayed using plugin descriptions (e.g. icons or descriptive text) to a user to select. The display of the plugin descriptions can be filtered based on a received input by the user, the context data, the target object, or a timeshare basis. Content data about the target object (e.g., first name=John, and last name=Smith) can be used in the displayed plugin descriptions. Other content data about the target object, e.g., home address and office address, can be displayed if the target object contains such content data. Additionally, placement of the plugins 521, 523, 525 can be based on a rating by a user of the UE 101 or a sale of a timeshare. Multiple plugins 521, 523, 525 to a single service provider 109 can be provided (e.g., for ordering a taxi online or for texting to order a taxi). When a plugin 521, 523, 525 is selected, an action associated with the plugin 521, 523, 525 can be executed. Thus, for example, when the plugin 521 is selected, a webpage can be opened to order a taxi to go to the home of John Smith. The plugin can use the current address (e.g., found as context information) of the user as input to where the taxi should arrive and the home of John Smith as an input to the destination. Additionally, when plugin 523 is selected, a text message can be sent to the taxi service to order a taxi to the current location of the user to arrive at the destination of John Smith's office.

In one embodiment, when plugin 525 is selected, a webpage to public transportation directions to can be opened. The current address of the UE 101 (found by e.g., contextual GPS information) can be an input as a starting location and John Smith's home can be an input as a destination location for the directions. Then, at user interface 540, the starting address location 541 and the destination address 543 of John Smith can be displayed to the user and the user is provided the option to confirm 545 the locations used for directions or cancel 547 the receiving the directions. Then, starting address location 541 and the destination address 543 are utilized as input parameters to the plugin by opening the associated public transportation directions in a browser interface 560. The browser interface 560 can display public transportation schedules based on the input parameters. For example, these input parameters can be utilized as start 561 and end 563 location parameters based on the starting address location 541 and destination address 543. The public transportation schedules can display timings of available public transportation routes to the destination from the current location. In this example, S1, S2, S3, S4, and S5 can represent stations that are associated with the public transportation service. S1 can correspond to the closest public transportation bus and/or train station to the current user location or address while S3 can represent the closest public transportation train station and S5 can represent the closest public transportation bus station to the destination address (i.e., home address of John Smith).

The processes described herein for providing expedited service integration using action plugin templates may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

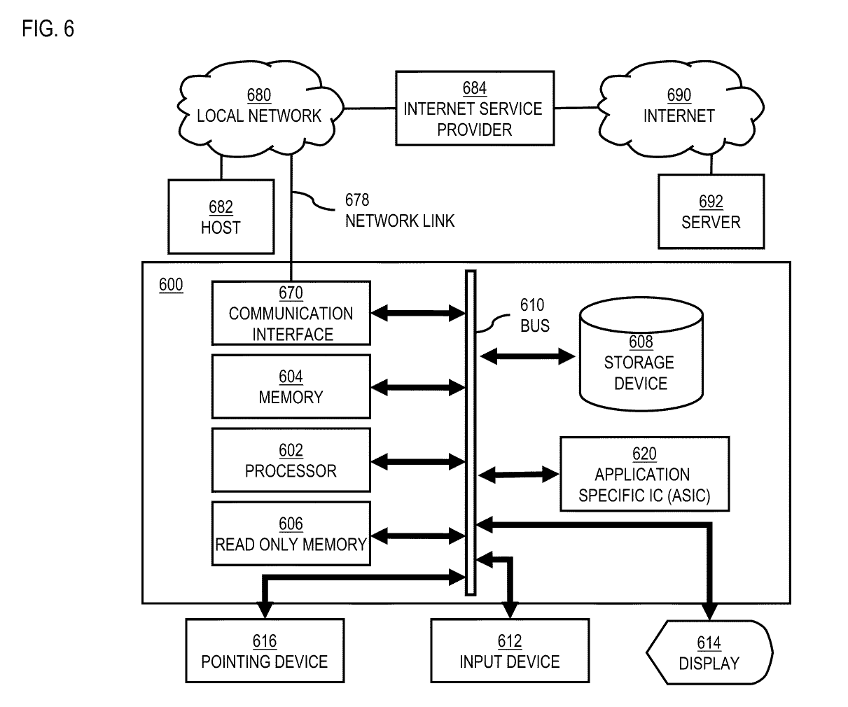

FIG. 6 illustrates a computer system 600 upon which an embodiment of the invention may be implemented. Computer system 600 is programmed (e.g., via computer program code or instructions) to provide expedited service integration using action plugin templates as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 610 includes one or more parallel conductors of information so that information is transferred quickly among devices coupled to the bus 610. One or more processors 602 for processing information are coupled with the bus 610.

A processor 602 performs a set of operations on information as specified by computer program code related to expedited service integration using action plugin templates. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or other dynamic storage device, stores information including processor instructions for providing expedited service integration using action plugin templates. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for expedited service integration using action plugin templates, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT) or a liquid crystal display (LCD), or plasma screen or printer for presenting text or images, and a pointing device 616, such as a mouse or a trackball or cursor direction keys, or motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of application specific ICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for service interaction to the UE 101.

The term computer-readable medium is used herein to refer to any medium that participates in providing information to processor 602, including instructions for execution. Such a medium may take many forms, including, but not limited to, non-volatile media, volatile media and transmission media. Non-volatile media include, for example, optical or magnetic disks, such as storage device 608. Volatile media include, for example, dynamic memory 604. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690. A computer called a server host 692 connected to the Internet hosts a process that provides a service in response to information received over the Internet. For example, server host 692 hosts a process that provides information representing video data for presentation at display 614.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set 700 upon which an embodiment of the invention may be implemented. Chip set 700 is programmed to provide expedited service integration using action plugin templates as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to expedited service integration using action plugin templates. The memory 705 also stores the data associated with or generated by the execution of the inventive steps.

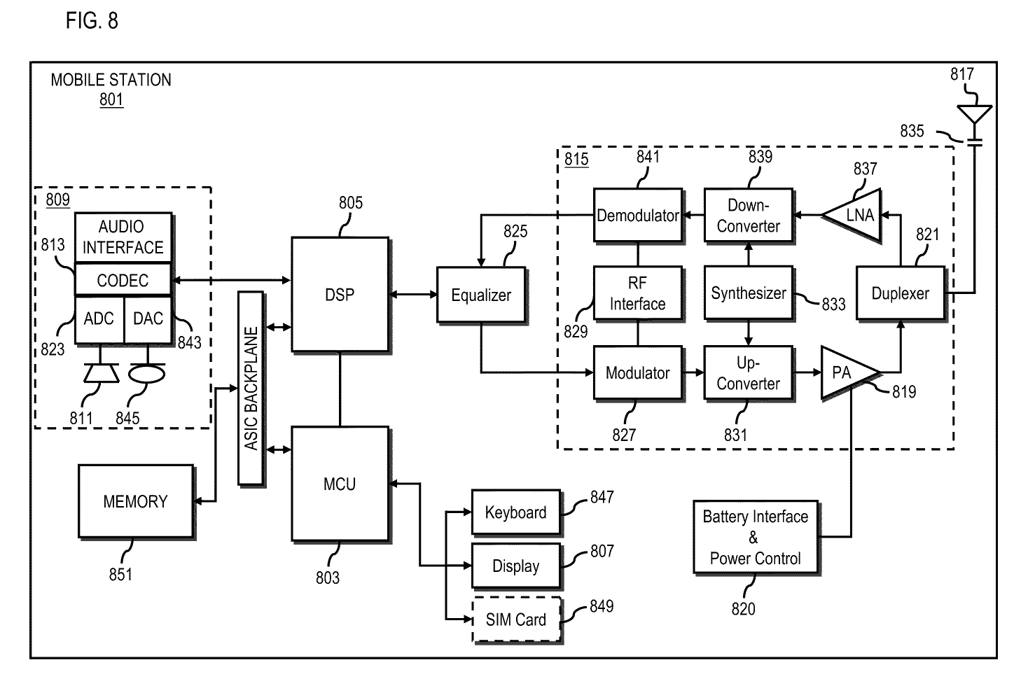

FIG. 8 is a diagram of exemplary components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions that offer automatic contact matching. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile station 801 to provide expedited service integration using action plugin templates. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining context information and a target object;
receiving a plugin based on a template configured for a service provider;
determining a plugin action using the target object and the context information; and
initiating execution of the plugin on the target object to perform the plugin action.

2. A method of claim 1, further comprising:
determining availability of the plugin for a target object based on a plugin type.

3. A method of claim 2, further comprising:
initiating display of a plugin description associated with the plugin based on the availability of the plugin.

4. A method of claim 3, further comprising:
filtering the display of the plugin description based on a received input, the context information, the target object, or a timeshare basis.

5. A method of claim 2, wherein the plugin type is associated with a type of the template, and wherein the plugin type is either a plugin type to open a universal resource locator in an application, a plugin type to handle a submission and reply, or a plugin type for messaging.

6. A method of claim 2, wherein the template specifies plugin parameters, and wherein the plugin parameters include content data about the target object and the context information.

7. A method of claim 1, wherein the plugin comprises a plugin type and a plugin configuration.

8. An apparatus comprising:
at least one processor; and
at least one memory including computer program code,
the at least one memory and the computer program code configured to, with the at least one processor, cause the apparatus to perform at least the following,
determine context information and a target object;
receiving a plugin based on a template configured for a service provider;
determining a plugin action using the target object and the context information; and
initiating execution of the plugin on the target object to perform the plugin action.

9. An apparatus of claim 8, wherein the apparatus is further caused to:
determine availability of the plugin for a target object based on a plugin type.

10. An apparatus of claim 9, wherein the apparatus is further caused to:
initiate display of a plugin description associated with the plugin based on the availability of the plugin.

11. An apparatus of claim 10, wherein the apparatus is further caused to:
filter the display of the plugin description based on a received input, the context information, the target object, or a timeshare basis.

12. An apparatus of claim 9, wherein the plugin type is associated with a type of the template, and wherein the plugin type is either a plugin type to open a universal resource locator in an application, a plugin type to handle a submission and reply, or a plugin type for messaging.

13. An apparatus of claim 9, wherein the template specifies plugin parameters, and wherein the plugin parameters include content data about the target object and the context information.

14. An apparatus of claim 8, wherein the plugin comprises a plugin type and a plugin configuration.

15. A computer-readable storage medium carrying one or more sequences of one or more instructions which, when executed by one or more processors, cause an apparatus to perform at least the following:
determine context information and a target object;
receiving a plugin based on a template configured for a service provider;
determining a plugin action using the target object and the context information; and
initiating execution of the plugin on the target object to perform the plugin action.

16. A computer-readable storage medium of claim 15, wherein the apparatus is further caused to:
determine availability of the plugin for a target object based on a plugin type.

17. A computer-readable storage medium of claim 16, wherein the apparatus is further caused to:
initiate display of a plugin description associated with the plugin based on the availability of the plugin.

18. A computer-readable storage medium of claim 17, wherein the apparatus is further caused to:
filter the display of the plugin description based on a received input, the context information, the target object, or a timeshare basis.

19. A computer-readable storage medium of claim 16, wherein the plugin type is associated with a type of the template, and wherein the plugin type is either a plugin type to open a universal resource locator in an application, a plugin type to handle a submission and reply, or a plugin type for messaging.

20. A computer-readable storage medium of claim 16, wherein the template specifies plugin parameters, and wherein the plugin parameters include content information regarding the target object and the context information.
